(19) United States
(12) Patent Application Publication
(10) Pub. No.: US 2026/0121686 A1
(43) Pub. Date: Apr. 30, 2026

(54) DATA TRANSMISSION DETECTION AND MITIGATION OVER ELECTRICAL POWER

(71) Applicant: International Business Machines Corporation, Armonk, NY (US)

(72) Inventors: Brian Charles Tucker, Clinton Corners, NY (US); Enver Candan, Cornwall, NY (US); Marc Henri Coq, Hopewell Junction, NY (US)

(21) Appl. No.: 18/925,614

(22) Filed: Oct. 24, 2024

(51) Int. Cl. H04B 3/54

(52) U.S. Cl. CPC H04B 3/54; H04B 2203/5495

(57) ABSTRACT

A method for data transmission detection and mitigation over electrical power includes supplying power to a data transmission detector and mitigator device. The method further includes monitoring, by the data transmission detector and mitigator device, AC voltage and AC current waveforms on at least one power line. The method further includes determining that a new frequency component is detected on the at least one power line based one or more modulation type profiles for recorded frequencies and magnitudes of the AC current waveforms

### BACKGROUND

This disclosure relates generally to data transmission detection, and in particular to data transmission detection and mitigation over electrical power lines.

Information Technology (IT) infrastructure includes various hardware that stores and processes sensitive data that is typically protected through multiple security methods. Though most modern security methods are directed to prevention of malicious access over network devices, cyber security intrusion, physical security is another method required to protect the hardware. Physical security relates to the prevention of physical access to the hardware that can include direct access to management console ports, data buses, storage devices, and any other device that is installed in a datacenter environment. Through physical access to the hardware there is an ability to send data in and out of the datacenter environment through power-line communication (PLC). By feeding data into a signal that can travel significant distances via power cabling, the data can be detected and decoded at a location external to the datacenter environment.

### SUMMARY

Embodiments in accordance with the present invention disclose a method, computer program product and computer system for data transmission detection and mitigation over electrical power, the method, computer program product and computer system can supply power to a data transmission detector and mitigator device. The method, computer program product and computer system can monitor, by the data transmission detector and mitigator device, AC voltage and AC current waveforms on at least one power line. The method, computer program product and computer system can determine that a new frequency component is detected on the at least one power line based one or more modulation type profiles for recorded frequencies and magnitudes of the AC current waveforms.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 depicts an example of a malicious actor utilizing a data transmitter and data transmitter for data transmission over electrical power, in accordance with an embodiment of the present invention.

FIG. 3 depicts an example schematic of a data transmission detector and mitigator device utilized by a data transmission detection program, in accordance with an embodiment of the present invention.

FIG. 4 depicts a flowchart of a data transmission detection program for detecting and mitigating data transmission over electrical power, in accordance with an embodiment of the present invention.

### DETAILED DESCRIPTION

Embodiments of the present invention provide data transmission detection and mitigation over electrical power. A data transmission detector and mitigator device (i.e., an interface unit) is electrically coupled to a power cable that is traversing a facility (e.g., datacenter), where the data transmission detector and mitigator device includes one or more analog-to-digital (A/D) convertors capable of acquiring voltage and current waveforms on the power cable. Embodiments of the present invention monitor incoming AC voltage and current waveforms and utilizing machine learning, a baseline representation of the incoming AC voltage and current waveforms is produced. The data transmission detector and mitigator device can include a microprocessor or digital signal processor (DSP) device to analyze historical power utilizing one or more modulation type profile and compare the one or more modulation type profiles to the instance waveform. Embodiments of the present invention logarithmically evaluate the data to allow visibility of smaller signals over the larger power waveform and detect if a new frequency component is present on the power line, that include but are not limited to, direct current (DC) offsets and repetitive signals of a given frequency.

Embodiments of the present invention allow for long-term recording of data for the AC voltage and current waveform with higher resolution capture when an event (i.e., new frequency component) is detected for further analysis and investigated by an external administrative user and/or system. The data transmission detector and mitigator device can further include a signal generator power amplifier for signal mitigation that is capable of generating a blanketing and/or masking signal on the power line that can impair the ability of an unwanted transceiver to send data. Embodiments of the present invention can also generate a random disruptive signal to prevent an operation of such devices, without prior detection having occurred of the new frequency component.

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

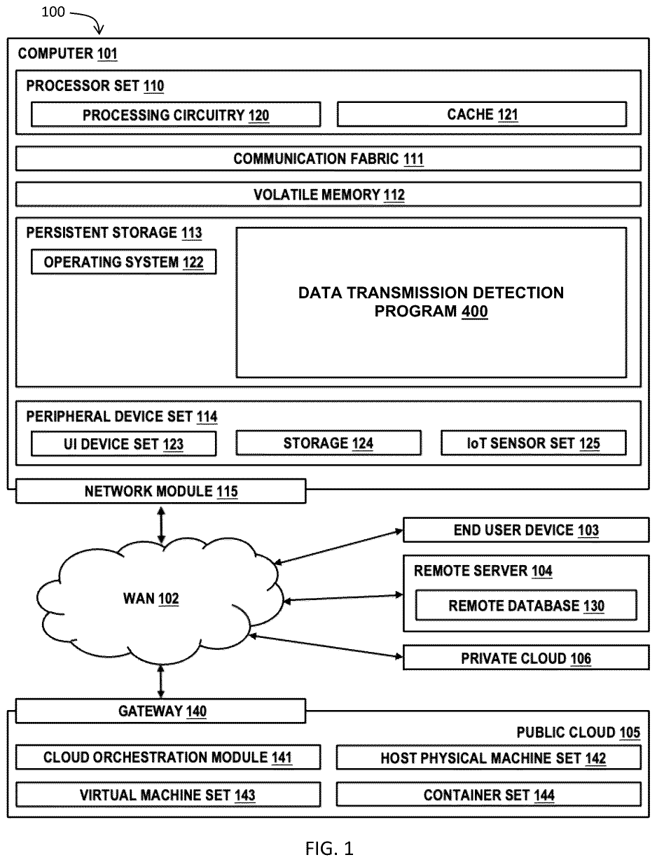

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as data transmission detection program 400. In addition to block 400, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 400, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 400 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 400 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

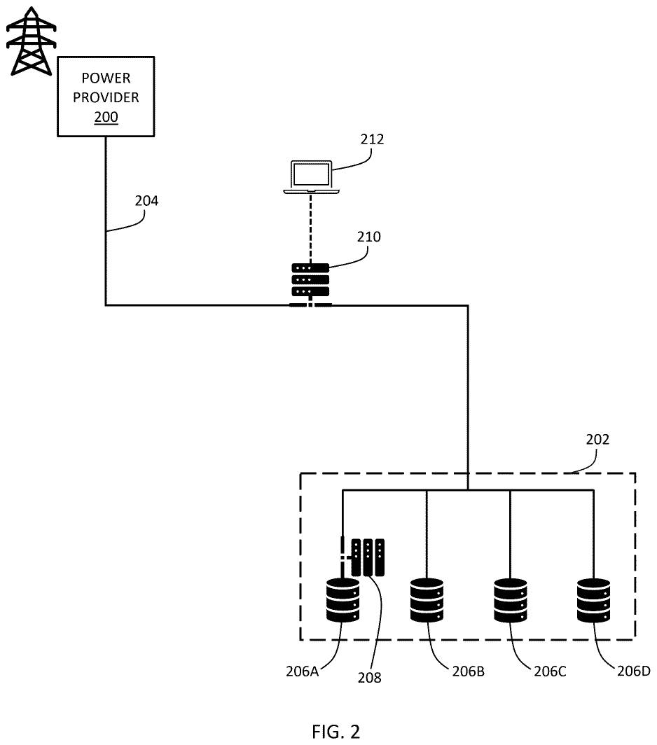

FIG. 2 depicts an example of a malicious actor utilizing a data transmitter and data transmitter for data transmission over electrical power, in accordance with an embodiment of the present invention.

In this embodiment, power provider 200 is transmitting electricity to datacenter 202 via power line 204, where power line 204 are electrically coupled to datacenter device 206A, 206B, 206C, and 206D. With power-line communication (PLC), a malicious actor has the ability to transmit data on a conductor (i.e., power line 204) that is simultaneously utilized for alternating current (AC) electric power transmission or electric power distribution to datacenter 202. By transmitting data, power line 204 become power-line carriers. By gaining access to datacenter 202, the malicious actor can electrically couple transmitter device 208 to power line 204 leading to one of datacenter devices 206A, 206B, 206C, and 206D. In this embodiment, the malicious actor electrically coupled transmitter device 208 to power line 204 leading to datacenter device 206A where the data is to be injected and electrically coupled receiver device 210 to power line 204 external to datacenter 202 where the data is to be collected. Transmitter device 208 and receiver device 210 represent electronic devices capable of modulating common protocols to send and receive data over power line 204. Transmitter device 208 injects data from datacenter device 206A into power line 204 via a signal, receiver device 210 collects the signal from power line 204, and the malicious actor with computing device 212 can translate the signal into readable data.

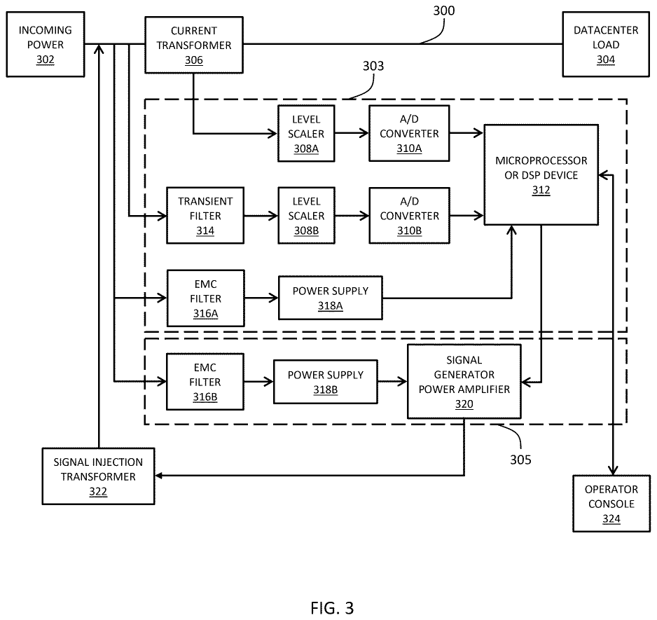

FIG. 3 depicts an example schematic of a data transmission detector and mitigator device utilized by a data transmission detection program, in accordance with an embodiment of the present invention.

In this embodiment, a schematic of data transmission detector and mitigator over electrical power device is provided for voltage and current monitoring of the AC power line 300, along with detecting and mitigating a signal over AC power line 300 that is present between incoming power 302 and datacenter load 304. Data transmission detector and mitigator device includes detector component 303 and mitigation component 305. Incoming power 302 represents a potential location of malicious data collection and datacenter load 304 represents a potential source of unwanted data injection. Current transformer 306 for reducing or multiplying an AC power is present on AC power line 300 between incoming power 302 and datacenter load 304, which leads to level scaler 308A for scaling of current and voltage through one or more voltage regulators. Level scaler 308A leads to analog-to-digital (A/D) converter 310A to cover the analog signal to a digital signal and A/D converter 310A leads to microprocessor or DSP device 312. An administrative user utilizing can send and receive data from microprocessor or DSP device 312 at operator console 324.

If receiving power directly from AC power line 300, transient filter 314 receives the power and suppresses voltage spikes or surges. Transient filter 314 leads to level scaler 308B, level scaler 308B leads to A/D converter 310B, and A/D converter 310B leads to microprocessor or DSP device 312. Power is supplied to microprocessor or DSP device 312 by receiving power from AC power line 300, which is passed through electromagnetic compatibility (EMC) filter 316A to filter high-frequency interference voltages and currents generated during normal operations and/or during instance of fault conditions. EMC filter 316A leads to power supply 318A for converting the electrical current from incoming power 302 to a required voltage, current, and frequency to power microprocessor or DSP device 312.

Power is supplied to signal generator power amplifier 320 by receiving power from AC power line 300, which is passed through electromagnetic compatibility (EMC) filter 316B to filter high-frequency interference voltages and currents generated during normal operations and/or during instance of fault conditions. EMC filter 316B leads to power supply 318B for converting the electrical current from incoming power 302 to a required voltage, current, and frequency to power signal generator power amplifier 320. Signal generator power amplifier 320 receives the signal to mitigate a detected malicious signal on AC power line 300 (i.e., a new frequency component), amplifies the signal, and sends the signal to signal injection transformer 322 to introduce the signal into AC power line 300 to mitigate the detected malicious signal. It is to be noted, that illustrated is just one example schematic of a data transmission detector and mitigator utilized by data transmission detection program 400.

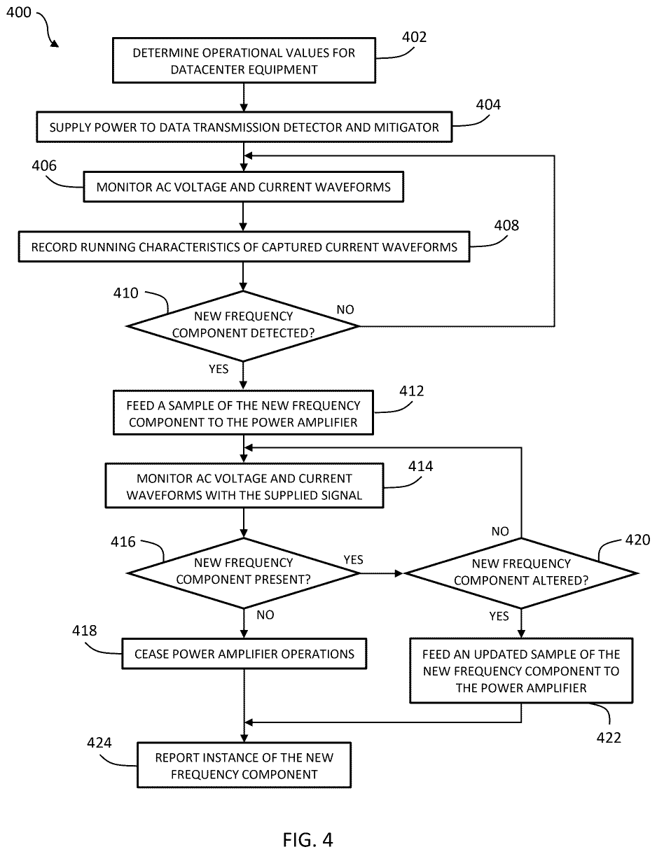

FIG. 4 depicts a flowchart of a data transmission detection program for detecting and mitigating data transmission over electrical power, in accordance with an embodiment of the present invention.

Data transmission detection program 400 determines operational values for datacenter equipment (402). Since the datacenter equipment operational values and power usage can vary depending on the time of day and day of the year, data transmission detection program 400 determines operational values for normal operating conditions for the datacenter equipment for a predetermined amount of time. For the predetermined amount time, data transmission detection program 400 collects the operational values that include AC voltage and current waveforms during normal operational activities. Data transmission detection program 400 utilizes the operational values for the datacenter equipment for baseline generation when detecting and mitigating any new frequency component on the AC power line.

Data transmission detection program 400 supplies power to data transmission detector and mitigator (404). Data transmission detection program 400 initializes the data transmission detector and mitigator device by supplying power to all the components and digital circuitry. The components and digital circuitry were previously discussed with regards to the example schematic in FIG. 3.

Data transmission detection program 400 monitors AC voltage and current waveforms (406). As electrical power is provided by a supplier to the datacenter, data transmission detection program 400 monitors the AC voltage and current waveforms as the electrical power passes through the data transmission detector and mitigator device.

Data transmission detection program 400 records running characteristics of captures current waveforms (408). Data transmission detection program 400 records running characteristics of captured AC current waveforms and maintains a list of frequencies and a respective magnitude for each of the captured AC current waveforms. Data transmission detection program 400 utilizes the recorded running characteristics as baseline readings and generates one or more modulation type profiles for the captured frequencies and the respective magnitude during normal operating conditions. Normal operating conditions represent baseline operating conditions for the electrical power being provided to the datacenter, where a malicious actor is not present. Data transmission detection program 400 performs continuous sampling through the monitoring of the AC voltage and current waveforms to determine whether a new frequency component is present on the power line.

Data transmission detection program 400 determines whether a new frequency component has been detected on the power line (decision 410). Data transmission detection program 400 determines whether a new frequency component has been detected on the power line by comparing a detected frequency to the one or more modulation type profiles. If data transmission detection program 400 determines the detected frequency is not present in the one or more modulation type profiles, data transmission detection program 400 determines the detected frequency is a new frequency component on the power line. If data transmission detection program 400 determines the detected frequency is present in the one or more modulation type profiles, data transmission detection program 400 determines the detected frequency is not a new frequency component on the power line.

In the event data transmission detection program 400 determines a new frequency component has been detected on the power line (“yes” branch, decision 410), data transmission detection program 400 feeds a sample of the new frequency component to the power amplifier (412). In the event data transmission detection program 400 determines a new frequency component has not been detected on the power line (“no” branch, decision 410), data transmission detection program 400 reverts to monitoring AC voltage and current waveforms (406).

Data transmission detection program 400 feeds a sample of the new frequency component to the power amplifier (412). In this embodiment, data transmission detection program 400 determines to feed the sample of the new frequency component to the signal generator power amplifier as a countermeasure to mitigate the potential malicious actor by canceling the new frequency component on the power line. The sample of the new frequency can be of greater magnitude than the detected frequency on the power line. After data transmission detection program 400 feeds the sample of the new frequency component to the signal generator power amplifier, the signal is passed to the signal injection transformer where it is injected back into the power line. In other embodiments, prior to preforming the countermeasure, data transmission detection program 400 sends a notification to an operator console associated with an administrative user. The notification indicates that a new frequency component was flagged as being present on the power line to the datacenter. The administrative user can investigate the presence of the new frequency component and data transmission detection program 400 can provide a countermeasure selectable option to the administrative use to mitigate the potential malicious actor. Machine learning can be utilized to further characterize the signals seen in the AC current waveform.

Data transmission detection program 400 monitors AC voltage and current waveforms with the supplied signal (414). As electrical power is continuously provided by a supplier to the datacenter, data transmission detection program 400 monitors the AC voltage and current waveforms as the electrical power passes through the data transmission detector and mitigator to see if the supplied signal has mitigated the new frequency component that was detected in (410).

Data transmission detection program 400 determines whether the new frequency component is still present (decision 416). Utilizing the sample of the new frequency component to the signal generated power amplifier, data transmission detection program 400 determines whether the new component is still present in the AC current waveforms. In the event data transmission detection program 400 determines the new frequency component is not present (“no” branch, decision 416), data transmission detection program 400 ceases power amplifier operations (418), thus stopping the sample of the new frequency component being fed to the power line. In the event data transmission detection program 400 determines the new frequency component is still present (“yes” branch, decision 416), data transmission detection program 400 determines whether the new frequency component is altered (decision 418).

Data transmission detection program 400 determines whether the new frequency component is altered (decision 420). In the event data transmission detection program 400 determines the new frequency component is altered (“yes” branch, decision 420), data transmission detection program 400 feeds an updated sample of the new frequency component to the power amplifier (422). In the event data transmission detection program 400 determines the new frequency component is not altered (“not” branch, decision 420), data transmission detection program 400 reverts to monitoring AC voltage and current waveforms with the supplied signal (414).

Data transmission detection program 400 feeds an updated sample of the new frequency component to the power amplifier (422). In this embodiment, data transmission detection program 400 determines to feed the updated sample of the new altered frequency component to the signal generator power amplifier to continue the countermeasure to mitigate the potential malicious actor by canceling the new updated frequency component on the power line. The updated sample of the new altered frequency can be of greater magnitude than the detected frequency on the power line. After data transmission detection program 400 feeds the sample of the new altered frequency component to the signal generator power amplifier, the signal is passed to the signal injection transformer where it is injected back into the power line.

Data transmission detection program 400 reports the instance of the new frequency component (424). In one embodiment, where data transmission detection program 400 determines the new frequency component is not present (“no” branch, decision 416) and ceases power amplifier operations (418), data transmission detection program 400 generates a report detailing the characteristics of the new frequency component and the successful deployment of the countermeasure to mitigate the new frequency component that is now no longer present on the power. An administrative user can further investigate this occurrence to determine if the new frequency component was malicious. In another embodiment, where data transmission detection program 400 determines the new frequency component is altered (“yes” branch, decision 420) and feeds an updated sample of the new frequency component to the power amplifier (422), data transmission detection program 400 generates a report detailing the characteristic of the new frequency component and the new altered frequency component that required the feeding of the updated sample to the signal generator power amplifier. Similar to the other embodiment, an administrative user can further investigate this occurrence to determine if the new frequency component and/or the new altered frequency component were malicious.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
supplying power to a data transmission detector and mitigator device;
monitoring, by the data transmission detector and mitigator device, AC voltage and AC current waveforms on at least one power line; and
determining that a new frequency component is detected on the at least one power line based on one or more modulation type profiles for recorded frequencies and magnitudes of the AC current waveforms.

2. The computer-implemented method of claim 1, further comprising:
recording running characteristics as baseline readings for the at least one power line, wherein the running characteristics include the recorded frequencies and the magnitudes of the AC current waveforms; and
generating the one or more modulation type profiles for the recorded running characteristics.

3. The computer-implemented method of claim 1, further comprising:
comparing a detected frequency on the at least one power line to the one or more modulation type profiles; and
determining the detected frequency is not present in the one or more modulation type profiles, wherein the detected frequency represents the new frequency component.

4. The computer-implemented method of claim 1, further comprising:
feeding, to a signal generator power amplifier, a sample of the new frequency component, wherein a signal injection transformer injects the sample of the new frequency component into the at least one power line.

5. The computer-implemented method of claim 4, further comprising:
monitoring, by the data transmission detector and mitigator device, AC voltage and AC current waveforms on at least one power line with the sample of the new frequency component;
determining that the new frequency component is not present on the at least one power line;
ceasing operations of the signal generator power amplifier; and
generating a report detailing characteristics of the new frequency component and a mitigation of the new frequency component.

6. The computer-implemented method of claim 4, further comprising:
monitoring, by the data transmission detector and mitigator device, AC voltage and AC current waveforms on at least one power line with the sample of the new frequency component;
determining that the new frequency component is present on the at least one power line;
determining that the new frequency component is altered; and
feeding, to the signal generator power amplifier, a new sample of the new altered frequency component, wherein the signal injection transformer injects the new sample of the new altered frequency component into the at least one power line.

7. The computer-implemented method of claim 6, further comprising:
generating a report detailing characteristics of the new frequency component and the new altered frequency component.

8. A computer program product comprising:
one or more computer readable storage media;
program instructions, stored on at least one of the one or more storage media, to supply power to a data transmission detector and mitigator device;
program instructions, stored on at least one of the one or more storage media, to monitor, by the data transmission detector and mitigator device, AC voltage and AC current waveforms on at least one power line; and
program instructions, stored on at least one of the one or more storage media, to determine that a new frequency component is detected on the at least one power line based on one or more modulation type profiles for recorded frequencies and magnitudes of the AC current waveforms.

9. The computer program product of claim 8, further comprising program instructions, stored on at least one of the one or more storage media, to:
record running characteristics as baseline readings for the at least one power line, wherein the running characteristics include the recorded frequencies and the magnitudes of the AC current waveforms; and
generate the one or more modulation type profiles for the recorded running characteristics.

10. The computer program product of claim 8, further comprising program instructions, stored on at least one of the one or more storage media, to:
compare a detected frequency on the at least one power line to the one or more modulation type profiles; and
determine the detected frequency is not present in the one or more modulation type profiles, wherein the detected frequency represents the new frequency component.

11. The computer program product of claim 8, further comprising program instructions, stored on at least one of the one or more storage media, to:
feed, to a signal generator power amplifier, a sample of the new frequency component, wherein a signal injection transformer injects the sample of the new frequency component into the at least one power line.

12. The computer program product of claim 11, further comprising program instructions, stored on at least one of the one or more storage media, to:
monitor, by the data transmission detector and mitigator device, AC voltage and AC current waveforms on at least one power line with the sample of the new frequency component;
determine that the new frequency component is not present on the at least one power line;
cease operations of the signal generator power amplifier; and
generate a report detailing characteristics of the new frequency component and a mitigation of the new frequency component.

13. The computer program product of claim 11, further comprising program instructions, stored on at least one of the one or more storage media, to:
monitor, by the data transmission detector and mitigator device, AC voltage and AC current waveforms on at least one power line with the sample of the new frequency component;
determine that the new frequency component is present on the at least one power line;
determine that the new frequency component is altered; and
feed, to the signal generator power amplifier, a new sample of the new altered frequency component, wherein the signal injection transformer injects the new sample of the new altered frequency component into the at least one power line.

14. The computer program product of claim 13, further comprising program instructions, stored on at least one of the one or more storage media, to:
generate a report detailing characteristics of the new frequency component and the new altered frequency component.

15. A computer system comprising:
one or more processors, one or more computer readable memories and one or more computer readable storage media;
program instructions, stored on at least one of the one or more storage media for execution by at least one of the one or more processors via at least one of the one or more memories, to supply power to a data transmission detector and mitigator device;
program instructions, stored on at least one of the one or more storage media for execution by at least one of the one or more processors via at least one of the one or more memories, to monitor, by the data transmission detector and mitigator device, AC voltage and AC current waveforms on at least one power line; and
program instructions, stored on at least one of the one or more storage media for execution by at least one of the one or more processors via at least one of the one or more memories, to determine that a new frequency component is detected on the at least one power line based on one or more modulation type profiles for recorded frequencies and magnitudes of the AC current waveforms.

16. The computer system of claim 15, further comprising program instructions, stored on at least one of the one or more storage media for execution by at least one of the one or more processors via at least one of the one or more memories, to:
record running characteristics as baseline readings for the at least one power line, wherein the running characteristics include the recorded frequencies and the magnitudes of the AC current waveforms; and
generate the one or more modulation type profiles for the recorded running characteristics.

17. The computer system of claim 15, further comprising program instructions, stored on at least one of the one or more storage media for execution by at least one of the one or more processors via at least one of the one or more memories, to:
compare a detected frequency on the at least one power line to the one or more modulation type profiles; and
determine the detected frequency is not present in the one or more modulation type profiles, wherein the detected frequency represents the new frequency component.

18. The computer system of claim 15, further comprising program instructions, stored on at least one of the one or more storage media for execution by at least one of the one or more processors via at least one of the one or more memories, to:
feed, to a signal generator power amplifier, a sample of the new frequency component, wherein a signal injection transformer injects the sample of the new frequency component into the at least one power line.

19. The computer system of claim 18, further comprising program instructions, stored on at least one of the one or more storage media for execution by at least one of the one or more processors via at least one of the one or more memories, to:
monitor, by the data transmission detector and mitigator device, AC voltage and AC current waveforms on at least one power line with the sample of the new frequency component;
determine that the new frequency component is not present on the at least one power line;
cease operations of the signal generator power amplifier; and
generate a report detailing characteristics of the new frequency component and a mitigation of the new frequency component.

20. The computer system of claim 18, further comprising program instructions, stored on at least one of the one or more storage media for execution by at least one of the one or more processors via at least one of the one or more memories, to:
monitor, by the data transmission detector and mitigator device, AC voltage and AC current waveforms on at least one power line with the sample of the new frequency component;
determine that the new frequency component is present on the at least one power line;
determine that the new frequency component is altered;
feed, to the signal generator power amplifier, a new sample of the new altered frequency component, wherein the signal injection transformer injects the new sample of the new altered frequency component into the at least one power line; and
generate a report detailing characteristics of the new frequency component and the new altered frequency component.
